(19) United States
(12) Patent Application Publication
(10) Pub. No.: US 2012/0296713 A1
(43) Pub. Date: Nov. 22, 2012

(54) System of Validating Online Advertising From Third Party Sources

(76) Inventor: Melih Abdulhayoglu, Montclair, NJ (US)

(21) Appl. No.: 13/472,276

(22) Filed: May 15, 2012

Related U.S. Application Data
(60) Provisional application No. 61/486,430, filed on May 16, 2011.

(51) Int. Cl. G06Q 30/02

(52) U.S. Cl. 705/14.4

(57) ABSTRACT

A system is provided for security and validation for online advertising from third party sources. The system identifies outgoing calls to known advertising networks when a DNS user loads a webpage by identifying the outgoing call via a link and investigating the DNS query being called. Once the advertiser network which was called has been identified, the system intercepts the call placed by the advertisement code and redirects the call to a server which holds validated and certified third party ads from a certified network. The certified ad platform answers and responds to the call by feeding back a certified advertisement to be displayed on the page of the web visitor page.

### CROSS REFERENCE TO RELATED APPLICATIONS

This application claims the benefit of priority to U.S. Provisional Application No. 61/486,430, filed May 16, 2011 which is incorporated herein in its entirety.

The present invention relates to a system of security and validation for online advertising from third party sources.

### BACKGROUND

There is a significant hole in Internet security which presents itself in most modern-day websites. Although the DNS networks can be secured through industry standards, such as DNSSEC, and the respective website can be secured via SSL, the websites that display advertisement via integrated code, and the advertising networks themselves, remain unmonitored.

There is currently a lack of trust in online advertisements due to this lack of monitoring. Unsecured or un-validated ad networks pose at least two potential and highly exploitable security risks. The two main risks are: 1.) rogue third party advertisement platforms and 2.) malformed, malicious, or otherwise harmful websites which deliver or advertise themselves on legitimate ad platforms.

With regard to the first stated risk, third-party ad providers spring up on the Internet all the time. Website owners (i.e., publishers), looking to monetize their website will place code on their web properties in order to display advertisements. Many of these publishers insert this third party code without any regard to the potential security threats that they may be exposing to themselves or to their website visitors.

As there are numerous different ad networks with various different sources and types of advertisements, the security risk is increased significantly from the advertising networks. When a publisher decides to place a third party's code into a website, the publisher opens up their site—and the viewers of that site—to the possible ills of whatever may be lurking behind that code.

Additionally, sometimes the potential security risk is from the website that a web surfer receives from legitimate ad networks, i.e.: a malformed, malicious, or otherwise harmful website can deliver or advertise themselves on legitimate ad platforms. While certain companies, such as Google, are considered top tier, highly trusted providers of advertisement content, the advertisers who use the platform of these companies may not be. Even though these companies maintain high standards across their advertisement platforms, the same cannot be said for all of the sites which make use of their platforms. This can give the Internet surfer a false sense of security when clicking on an advertisement from a company which is a known and trusted provider of ad content, such as Google. An advertisement which is delivered by a top-tier ad platform does not guarantee the site which a visitor receives when clicking on the advertisement is going to be safe, secure, or even legitimate.

### SUMMARY

The present invention overcomes the difficulties mentioned above by providing a solution to create trust in advertisements. By creating a system of advertisement validation, the present invention allows trusted providers the ability to show their ads to visitors on a secure DNS platform, only if providers have passed security checks and have become validated by a single platform, such as by DNS.COM/COMODO.COM.

While DNS systems can be secured from end-to-end with industry standards like DNSSEC, and websites can be secured with an SSL certificate, allowing unchecked third party code into a website opens a portal that can sidestep many security features since webmasters often naively view these advertising platforms as harmless. Further, advertisement platforms have been known to trade in malicious traffic, bot traffic, spam traffic and other nefarious sources. Allowing unfettered access (via a consistently open portal) to an individual's website therefore, creates a recipe for catastrophe. Advertisements have also been known to crash PC's, browsers, contribute to buffer overruns, and promote sites that may be infected with spyware, malware, or all of the above. The present invention, however, prevents malicious code access and also ensures that rogue and uncertified advertisement networks do not obtain access to display their ads to DNS clients.

This is accomplished in the present invention by an “intercept and replace” system that identifies outgoing calls to all known ad networks when a user (who uses DNS) loads a webpage. The present invention identifies the outgoing call via the link by investigating the URL being called. For example, in Google's ad platform “DoubleClick.net”, the URL being called: http://ad.doubleclick.net/123456/flash movie.swf?clickTag1%c&clickTag2=http://ad.doublecl ick.net/clk;1234567;987456;f

When the system of the present invention sees an advertiser network URL being called (like that of above, and as shown in FIG. 1a), the system's intercept and replace (IR) feature intercepts the call placed by the advertisement code and redirects the call to a server which holds certified third party ads from a network which is certified. The certified ad platform would “answer” this call by feeding back an advertisement to be displayed on the web visitor's page.

With the “intercept and replace” system of the present invention, any advertisement network that is identified as a “rogue” network will have their advertisements intercepted before they reach the user's browser and replaced with known validated advertisements from third party advertisers which are certified safe by a reliable source, such as by COMODO Security. In order to ensure that each advertisement platform is safe for DNS users, each individual advertisement platform is certified by a reliable source, such as COMODO, just as each individual website has to submit to an SSL provider in order to have their own websites proven secure.

With the present invention, there is provided a system for validating advertising from third party sources which includes a computer or handheld device with online access configured for DNS use (through the operating system). With the system, a DNS user of the computer or the handheld device accesses a webpage online where the webpage includes an advertisement code to send to advertisement networks. The system includes an investigation process which identifies outgoing calls from the webpage to the advertisement networks when the DNS user loads the webpage with the investigation process identifying outgoing calls by seeing a DNS query of the advertisement network being called. The system intercepts the outgoing calls placed by the advertisement code and redirects the call to a server which has certified third party ads from a certified advertisement network, such as Comodo. The certified advertisement network answers the outgoing call by feeding back a certified advertisement to be displayed on the webpage.

The present invention includes a method for certifying advertisements from third party sources which includes accessing a webpage online by a DNS user of a computer or handheld device which is configured for DNS use and where the webpage contains an advertisement code to send to advertisement networks. The certification method identifies outgoing calls from the webpage to the advertisement networks when the DNS user loads the webpage by an investigation process. Within the investigation process, the outgoing calls are identified by seeing a DNS query of the advertisement network which is called. The method intercepts the outgoing calls placed by the advertisement code and redirects the call to a server having certified third party ads from a certified advertisement network, such as those certified by Comodo. The method of the invention answers the outgoing call by sending back a certified advertisement from the certified advertisement network to be displayed on the webpage.

### BRIEF DESCRIPTION OF THE DRAWINGS

The accompanying drawings illustrate various embodiments of the present invention and system and are a part of the specification. The illustrated embodiments are merely examples of the present system and invention and do not limit the scope thereof.

FIG. 1a is a schematic of a user accessing a website from a computer or handheld device.

FIG. 1b illustrates a standard computer system or computing device.

FIG. 1c illustrates a website with an advertisement located within a web browser window and the query status bar.

FIG. 2a is a schematic illustration of how advertisements are received into a known website.

FIG. 2b illustrates a sample of code for a webpage which includes an advertisement code.

FIG. 3 is a schematic illustration of the system of the present invention where validated advertisements are received from a trusted ad server,

FIG. 4 is a flow diagram of the system of the present invention.

FIG. 5 is a system work flow diagram of the present invention.

### DETAILED DESCRIPTION

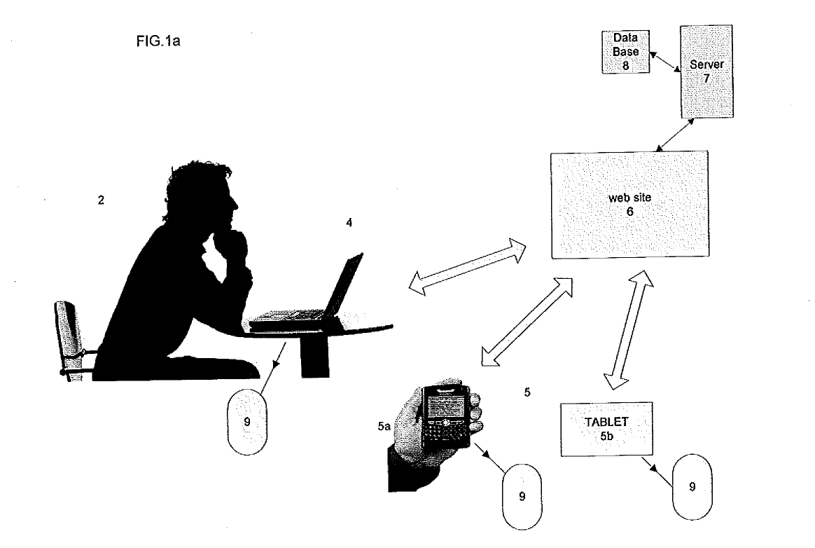

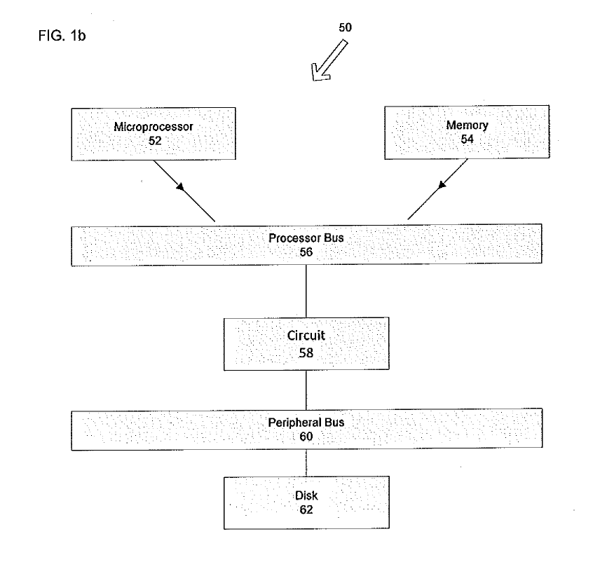

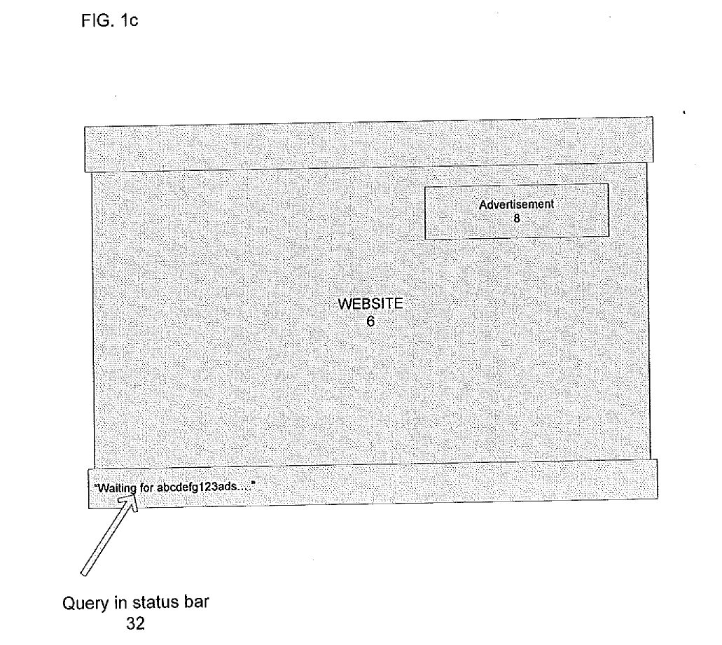

As shown generally by FIG. 1a, there is a user 2 of a computer 4 or handheld device 5 who accesses an Internet website 6 with network connections to a server 7 and database 8. The user 2 is potentially exposed to many malicious or unsafe advertisements located on the website 6 due to lack of security and validation with the advertising source, even though the website 6 itself may be known as reliable and trusted. Those of skill in the art would recognize that the computer 4 or hand held devices 5a or 5b each has a processor and a memory coupled with the processor where the memory is configured to provide the processor with executable instructions. A boot disk 9 is present for initiating an operating system as well for each of the computer 4 or hand held devices 5. It should also be noted that as used herein, the term handheld device includes phones, smart phones, tablets, personal digital assistants, media and game players and the like. As used throughout, the term “query” or “queries” is used in the broadest manner to include requests, polls, calls, summons, queries, and like terms known to those of skill in the art.

FIG. 1b Illustrates a system 50 of a computer or device which includes a microprocessor 52 and a memory 54 which are coupled to a processor bus 56 which is coupled to a peripheral bus 60 by circuitry 58. The bus 60 is communicatively coupled to a disk 62. It should be understood that any number of additional peripheral devices are communicatively coupled to the peripheral bus 60 in embodiments of the invention. Further, the processor bus 56, the circuitry 58 and the peripheral bus 60 compose a bus system for computing system 50 in various embodiments of the invention. The microprocessor 52 starts disk access commands to access the disk 62. Commands are passed through the processor bus 56 via the circuitry 58 to the peripheral bus 60 which initiates the disk access commands to the disk 62. In various embodiments of the invention, the present system intercepts the disk access commands which are to be passed to the hard disk.

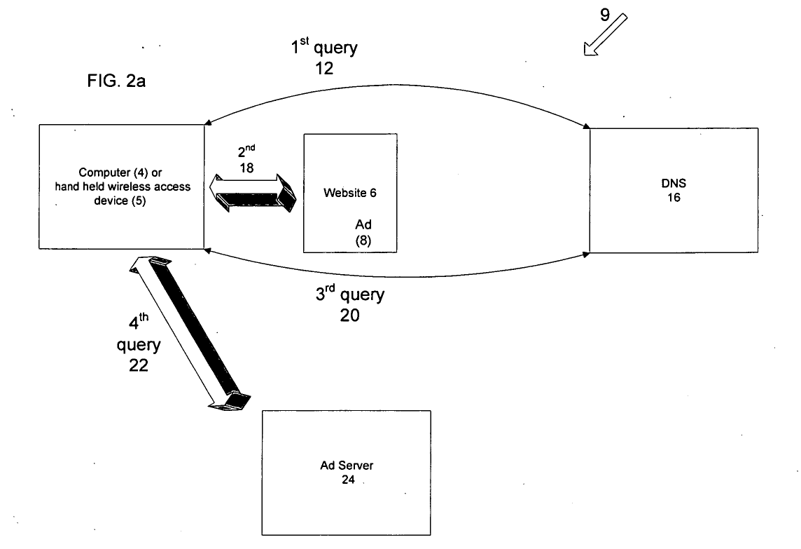

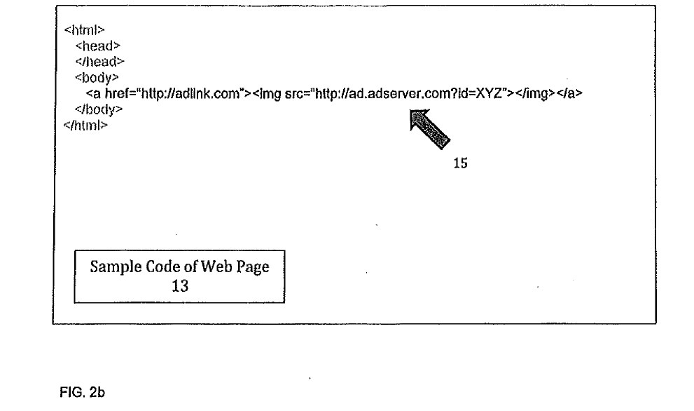

The prior art process 9 of how advertisements are sent to a particular website 6 is illustrated with reference to FIG. 2a and FIG. 2b. The prior art process 9 includes a computer 4 or hand held wireless access device 5 which seeks to access a website 6 which has one or more advertisements 8 on the particular website 6. The visual display and page layout of the website 6 is determined by the code for the particular page. FIG. 2b illustrates a sample of an overall page code for displaying a typical website 6 with an advertisement 8, and containing an advertisement code 15 located within the overall webpage code 13. The advertisements 8 associated with the advertisement code 15 are located and stored at ad server 24 until requested to fill a location on a particular webpage 6. In practice, the user 2 would request a particular website, and a first query, indicated by double arrow 12, is made to a domain name service (DNS) to identify and locate the IP address which is then sent back to the user 2. A second query is then made, indicated by double arrow 18, to the website 6 which includes one or more advertisements 8, to identify and receive the particular HTML for the particular page. Then, a third query is made, indicated by double arrow 20, from the computer 4 or device 5 to the DNS 16 to identify and locate the address for the ad server 24 which is associated with the advertisements 8 and advertisement code 15 to be located on the particular website 6. The ad server 24 is then queried, indicated as double arrow 22, by the computer 4 or hand held device 5 to retrieve the particular advertisements) 8 which fills the appropriate location(s) on the website 6. The advertisements 8 which are received from ad server 26, however, have not been validated and may contain malicious, malformed, or harmful code.

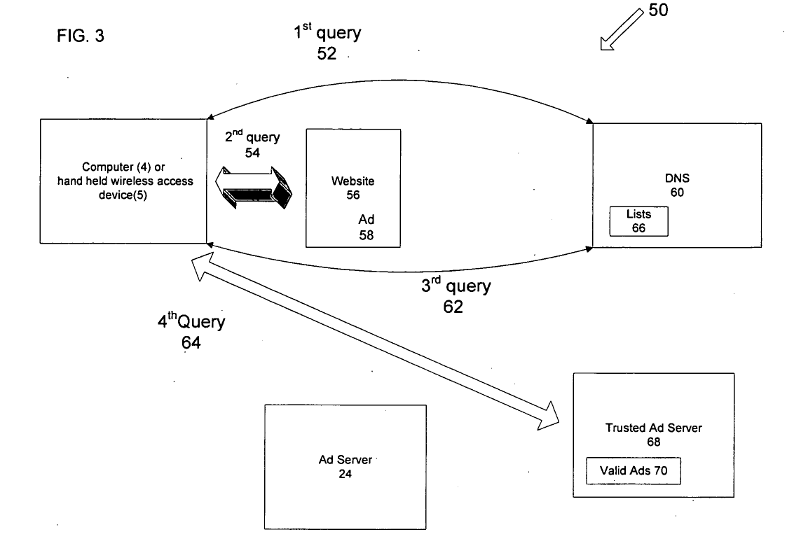

Referring to FIG. 3, there is shown an illustration of present invention 50 where advertisements on websites 56 are replaced with validated and trusted advertisements from a trusted ad server 68. With the present invention 50, the user 2 again requests a particular website 56, and the first query, indicated by double arrow 52, is made to a domain name service (DNS) 60 to identify and locate the IP address which is then sent back to the user 2. A second query is again made, indicated by double arrow 54, to the website 56 which includes one or more locations for advertisements 58, to identify and receive the particular HTML for the particular page. Then, a third query is made, indicated by double arrow 62, from the computer 4 or device 5 to the DNS 60 to identify and locate the address for the ad server 24 which is originally associated with the advertisements 58 to be located on the particular website 56. With the present invention, however, the DNS 60 sends a response to the query 62 back to the device 5 or computer 4 which identifies a trusted ad server 68. Once the computer 4 or device 5 makes the fourth query to retrieve the advertisement from ad server 24, at this point, the present invention 50 redirects the query, indicated by double arrow 64, to a trusted ad server 68 to replace the particular advertisement(s) 8 which fills the appropriate location(s) on the website 6. The trusted and validated advertisements 70 which are stored on and received from trusted ad server 68 have previously been validated as safe and secure and do not contain malicious, malformed, or harmful code. in this manner, only these certified and validated advertisements 70 are installed onto the website 56 and replace the unknown or potentially harmful advertisements from ad server 24.

The system of the present invention 50 becomes incorporated into existing networks depending on the manner of use. Internet Service Providers (ISPs) might send out the desired DNS resolvers IP's through the client's DHCP lease or a user may select to statically set the DNS resolvers in their operating systems configuration. With any manner of use, however, the client's operating system needs to be configured to use the predetermined DNS resolvers. Once configured, the user has access to the recursive DNS service 60 of the present invention which maintains a list of hosts 66 that are known to be servicing ads. With the present invention 50, rogue advertisement networks can be identified by through dictionary lists 66 stored at DNS 60 which identify classifications of host records, i.e. malware, phishing, spyware, adult content etc. These lists 66 then define how the DNS 60 should respond to the query for advertisement addresses. Identification of new or unknown rogue networks may be accomplished by behavioral based algorithms, such as indicated in Exposure research paper http://www.iseclab.org/papers/blige-ndss11.pdf incorporated herein by reference.

In this manner, when the third query 62 is made to the DNS 60, the response is changed or overwritten based on an investigation of the lists 66 to assure that the user's computer 4 or hand held device 5 directs the fourth query 64 to a trusted ad server 68. Once the response is altered, then only the trusted ad server 68 will service the website ad 58 from valid advertisements 70 which have been certified as safe and secure by a reliable source, such as Comodo. The trusted ads 70 may be selected randomly or by a predetermined method from within the trusted ad server 68. Each visit to the website 56 by the same or different users may include a new validated ad 70 from a stock selection. Additionally, the validated advertisements 70 may need to be cropped or formatted for the correct size dimensions on a particular website 56. Once this is accomplished, the trusted ad 70 from the trusted server 68 then appears on the website 56 at the appropriate location for the website advertisement 58.

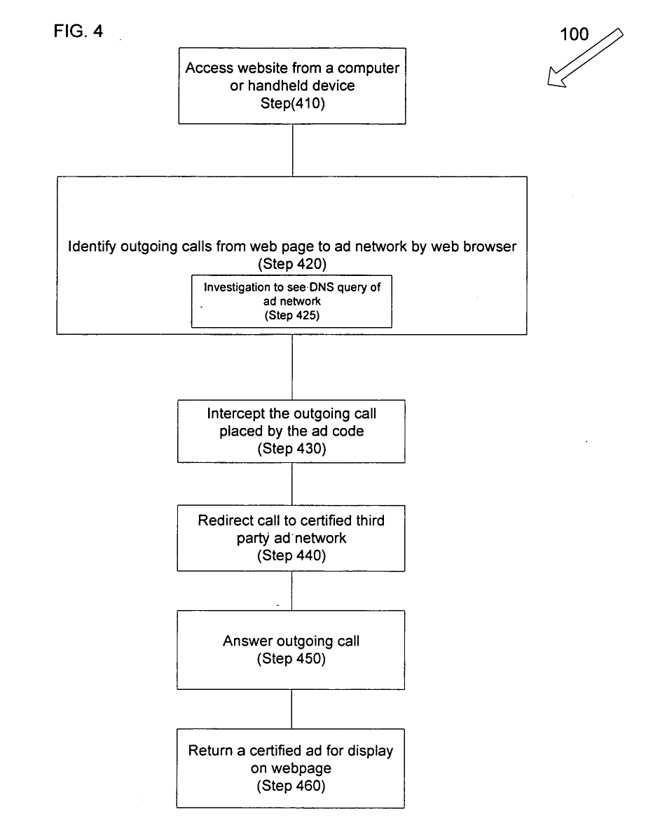

Referring to FIG. 4, there is shown a method 100 of the present invention 50 for certifying and validating advertisements from third party sources. The method includes the steps of accessing an Internet webpage online by a DNS user 2 with a computer or a handheld device 4 or 5 configured for DNS (Step 410).

The webpage 6 includes an advertisement code 15 to send to advertisement networks 24 so that an advertisement may be relayed back and placed on the website 6. Next, the method of the invention identifies outgoing calls 52 and 62 from the webpage 6 via a web browser to the advertisement networks 24 when the DNS user 2 loads the webpage 56. This is accomplished by an investigation process of the lists 66 which sees a DNS query 62 of the advertisement network 24 being called. (Step 420 and Step 425).

The validation method then intercepts the outgoing calls 62 placed by the advertisement code 15 (Step 430) and redirects the call to a server 68 having certified third party ads 70 from a certified advertisement network. (Step 440). The method of validation then answers the outgoing call 64 by sending back a certified advertisement 70 from the certified advertisement network server 68 to be displayed on the webpage 56. (Step 450). In this manner, the potentially malicious advertisement for the webpage is replaced by a certified and validated advertisement 70 from a trusted advertisement network source which has already been verified by reliable sources, such as Comodo.

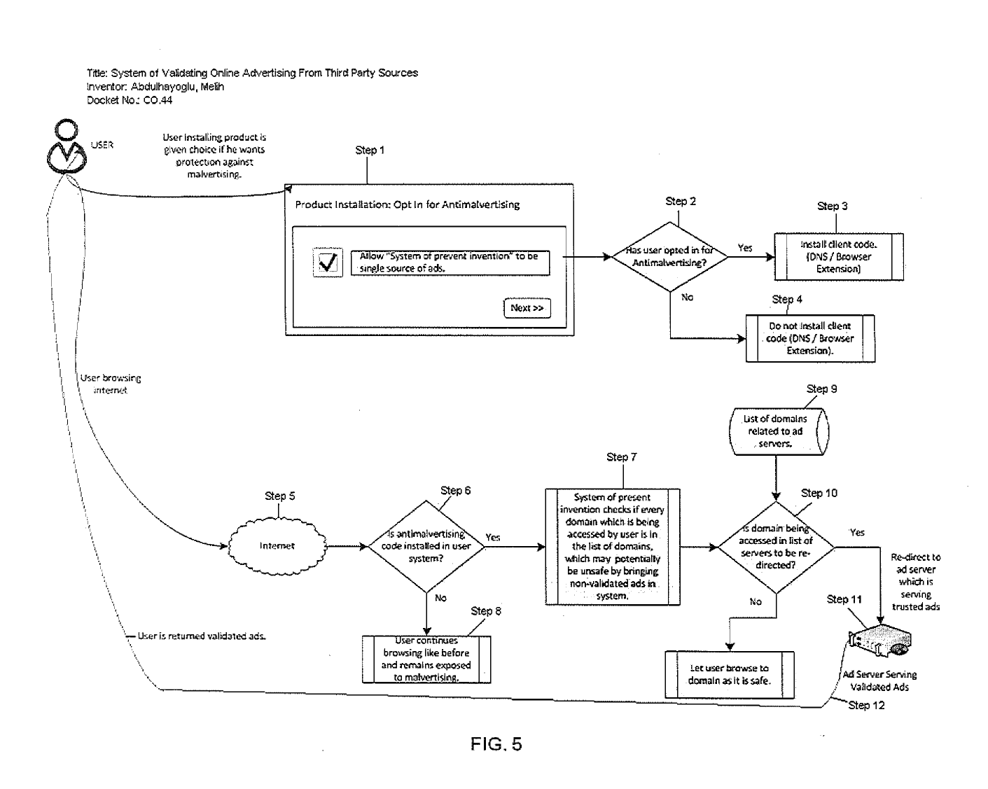

Referring to FIG. 5 there is shown a system work flow diagram of the present invention. In step 1 of FIG. 5, the user begins by installing the system of the present invention on a personal computing device. When installing the system, the user is presented with the option wherein the user chooses to allow the antimalvertising system of the present invention to be the only source of advertisements served or delivered to the user's personal computing device. If the user choose opts into the antimalvertising system, then in step 3 the client code (DNS/Browser Extension) is installed. If the user elects to not install the antimalvertising system, then as shown in step 4, no action is taken and the client code is not installed.

When the user has elected to install the antimalvertising system, the system is engaged when the user is browsing the internet as depicted in step 5. As stated above, if the antimalvertising system is installed then the system proceeds to step 7. If the antimalvertising system is not installed, then the user continues browsing the Internet normally as depicted in step 8. Turning again to step 7, when the user is using the antimalvertising system of the present invention, the system monitors each domain that the user's browser is attempting to access. The system checks each of the domains that the user is attempting to access against a list stored in a database, step 9, which lists domains may be potentially unsafe. Potentially unsafe domains include those domains that serve non-validated advertisement to the users system. In step 10, if the domain being accessed is in a list of servers to be re-directed, those potentially serving un-safe ads, then the users system is re-directed to an ad server that is serving trusted ads, step 11, and the trusted ads are returned to the user, step 12. If in step 10, the domain being accessed is not potentially serving un-safe ads, then in accordance with step 13, the user is permitted to access the domain as it is a safe domain, having been previously validated as not serving malvertising.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for validating advertising from third party sources comprising:
a computer or handheld device with online access configured for DNS use;
a DNS user of said computer or said handheld device accessing a webpage online;
said webpage having an advertisement code to send to advertisement networks;
an investigation process which identifies outgoing calls from said webpage to said advertisement networks when said DNS user loads said webpage, said investigation process identifying outgoing calls by seeing a DNS query of said advertisement network being called;
the system intercepting the outgoing calls placed by the advertisement code and redirecting the call to a server;
said server having certified third party ads from a certified advertisement network;
said certified advertisement network answering said outgoing call by feeding back a certified advertisement to be displayed on said webpage.

2. A method for certifying advertisements from third party sources comprising the steps of:
accessing a webpage online by a DNS user of a computer or handheld device configured for DNS use;
said webpage having an advertisement code to send to advertisement networks;
identifying outgoing calls from said webpage to said advertisement networks when said DNS user loads said webpage by an investigation process which sees a DNS query of said advertisement network being called;
intercepting the outgoing calls placed by the advertisement code;
redirecting the call to a server having certified third party ads from a certified advertisement network;
answering said outgoing call by sending back a certified advertisement from said certified advertisement network to be displayed on said webpage.
